(19) United States
(12) Patent Application Publication
(10) Pub. No.: US 2015/0219328 A1
(43) Pub. Date: Aug. 6, 2015

(54) LED LIGHTING FIXTURE

(71) Applicant: Lediammond Opto Corporation, New Taipei City (TW)

(72) Inventors: Hsuan-Hsien LEE, New Taipei City (TW); Chung-Ting TSENG, New Taipei City (TW); Peng-Yu CHEN, New Taipei City (TW)

(73) Assignee: Lediammond Opto Corporation, New Taipei City (TW)

(21) Appl. No.: 14/174,061

(22) Filed: Feb. 6, 2014

(51) Int. Cl. F21V 29/508; F21K 99/00; F21V 23/00

(52) U.S. Cl. CPC F21V 29/508; F21V 23/005; F21K 9/54; F21Y 2105/005

(57) ABSTRACT

A LED lighting fixture includes a control circuit board, a plurality of lighting modules and a light reflective shield. Each one of the lighting modules includes a transparent substrate disposed of a plurality of LED chips; each one of the transparent substrates is electrically connected to the control circuit board, and the LED chips are electrically connected to the control circuit board via the transparent substrate. One side of each one of the transparent substrates is arranged adjacent to each other such that the transparent substrates are disposed in a radial pattern. The light reflective shield is for accommodating the control circuit board therein and surrounding the lighting modules. Therefore, the LED lighting fixture of the present invention is able to generate a uniformly distributed illumination while reducing the heat generated by the LED chips.

### BACKGROUND OF THE INVENTION

1. Field of the Invention

The present invention is related to a light emitting diode (LED) lighting fixture, in particular, to an LED lighting fixture capable of generating a uniformly distributed illumination.

2. Description of Related Art

For a conventional LED lighting fixture, it typically includes at least one circuit board and a plurality of LEDs provided on the circuit board such that the LEDs can be used for generating light during operation. However, the structure of such conventional lighting fixture tends to hinder its own illumination caused by the shading of the circuit board at certain angles, which is a typical drawback mainly due to the directional characteristic of the light emitted by LEDs.

Therefore, a known LED lighting fixture may then use an LED of a higher power for illumination along with the design of a secondary lens for deflecting the light in order to compensate the drawback of the narrow angle of illumination by LEDs. Nevertheless, such use of higher power LEDs also generates a larger amount of heat, and such known LED lighting fixture must also have a heat dissipating mechanism (such as a heat sink). As heat sink mechanisms are mostly made of metals that are of high cost in addition to that a secondary lens with a higher precision would also cost high, the overall manufacturing cost of known LED lighting fixtures is increased significantly.

In view of the above, the inventor(s), after years of research and development along with the application of theoretical principles, seeks to overcome the aforementioned drawbacks associated with the know arts and current techniques by providing the present invention with improvements over the known arts.

### SUMMARY OF THE INVENTION

The present invention is to provide an LED lighting fixture capable of generating a uniformly distributed illumination.

Accordingly, the present invention provides an LED lighting fixture, comprising a control circuit board, a plurality of lighting modules and a light reflective shield. Each one of the lighting modules comprises a transparent substrate having a plurality of LED chips disposed thereon; each one of the transparent substrates is electrically connected to the control circuit board and the plurality of LED chips are electrically connected to the control circuit board via the transparent substrates; one side of each one of the transparent substrates is arranged adjacent to each other; and the plurality of transparent substrates are arranged in a radial pattern. The light reflective shield is used for accommodating the control circuit board therein and surrounding the plurality of lighting modules.

Preferably, in the aforementioned LED lighting fixture, a bottom edge of each one of the plurality of transparent substrates is perpendicularly attached to the control circuit board.

Preferably, in the aforementioned LED lighting fixture, a bottom edge of each one of the plurality of transparent substrates includes an insertion piece extended therefrom; the control circuit board includes locking slots corresponding to each one of the insertion pieces; the insertion pieces are inserted into the locking slots.

Preferably, in the aforementioned LED lighting fixture, the insertion pieces are electrically connected to the locking slots.

Preferably, in the aforementioned LED lighting fixture, the plurality of transparent substrates are arranged at an equal angle among each other.

Preferably, the aforementioned LED lighting fixture further comprises a power circuit board electrically connected to the control circuit board.

Preferably, in the aforementioned LED lighting fixture, a top edge of the power circuit board is perpendicularly connected to the control circuit board.

Preferably, in the aforementioned LED lighting fixture, the top edge of the power circuit board includes an insertion piece extended therefrom; the control circuit board includes a locking slot corresponding to the insertion piece; the insertion piece is inserted into the locking slot.

Preferably, in the aforementioned LED lighting fixture, the insertion piece is electrically connected to the locking slot.

Preferably, in the aforementioned LED lighting fixture, the power circuit board and the plurality of transparent substrates are arranged at two opposite sides of the control circuit board.

Preferably, in the aforementioned LED lighting fixture, an inner wall of the light reflective shield includes a plurality of flat light reflective surfaces arranged to face toward different directions.

Preferably, in the aforementioned LED lighting fixture, the plurality of light reflective surfaces are arranged to face toward the plurality of lighting modules.

Preferably, in the aforementioned LED lighting fixture, an inner wall of the light reflective shield includes a light reflective surface, and the light reflective surface is a smoothly curved surface.

The LED lighting fixture of the present invention is able to overcome the drawback of the narrow angle of illumination of LED chips by arranging the lighting modules in a radial pattern in order to allow the LED chips to generate a uniformly distributed illumination altogether and such that the working power required by the LED chips is lower and the heat generated by the LED chips are further decreased as well. In addition, the LED lighting fixture of the present invention is able to use the light reflective shield to reflect the light while adjusting its direction of light projection and the shape of the illumination; therefore, there is no need for a secondary lens. In view of the above, the LED lighting fixture of the present invention is able to effectively overcome the drawbacks of the known arts in addition to the merit of without the uses of a heat dissipating mechanism and a secondary lens advantageously.

### BRIEF DESCRIPTION OF DRAWING

FIG. 1 is an exploded view of a preferred embodiment of the LED lighting fixture of the present invention showing the control circuit board and the lighting modules thereof;

FIG. 2 is an exploded view of a preferred embodiment of the LED lighting fixture of the present invention;

FIG. 3 is a perspective view of a preferred embodiment of the LED lighting fixture of the present invention;

FIG. 4 is a top view of a preferred embodiment of the LED lighting fixture of the present invention;

FIG. 5 is a cross sectional view of a preferred embodiment of the LED lighting fixture of the present invention;

FIG. 6 is an illustration showing another example of a preferred embodiment of the LED lighting fixture of the present invention;

FIG. 7 is an illustration showing yet another example of a preferred embodiment of the LED lighting fixture of the present invention;

FIG. 8 is a cross sectional view of the LED lighting fixture in FIG. 7.

### DETAILED DESCRIPTION OF THE INVENTION

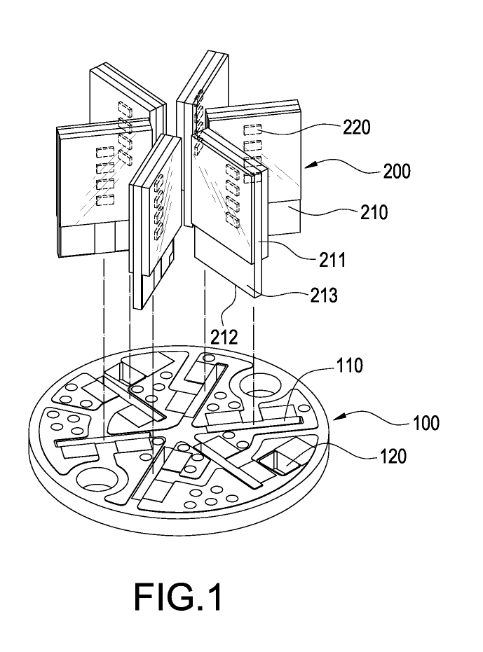

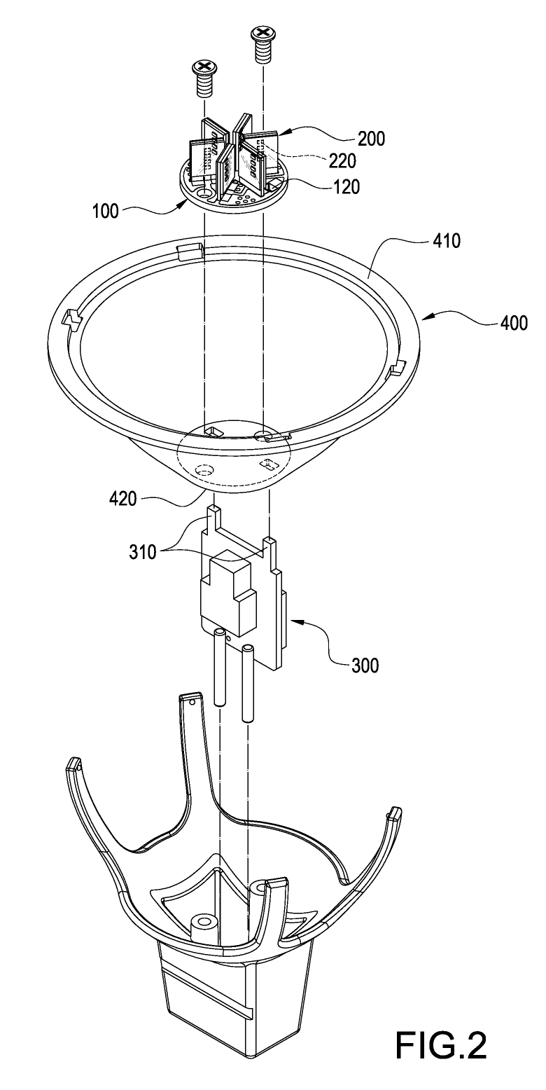

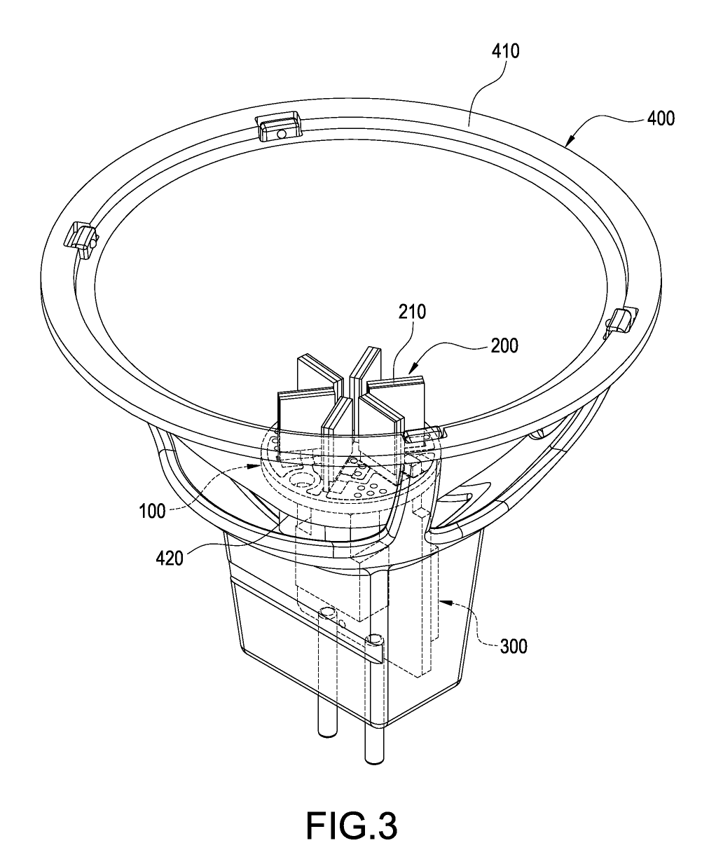

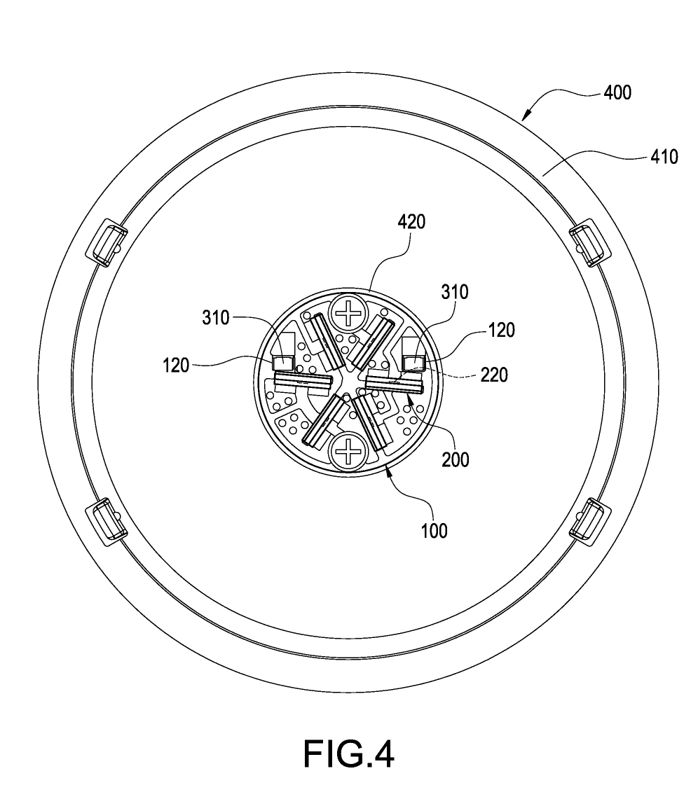

Please refer to FIG. 1 to FIG. 5. According to a preferred embodiment of the present invention, an LED lighting fixture comprises a control circuit board 100, six lighting modules 200, a power circuit board 300 and a light reflective shield 400.

The control circuit board 100 is a circular board having seven pairs of locking slots 110/120 formed thereon. In this embodiment, six pairs of locking slots 110 are elongated rectangular locking slots 110 arranged in a radial pattern, and angles between any two of the adjacent locking slots are identical (such as 60 degree). The other pair of locking slots 120 is a pair of rectangular locking slots 120.

The six lighting modules 200 are arranged corresponding to the aforementioned locking slots 110 disposed in a radial direction. Each one of the lighting modules 200 comprises a transparent substrate 210; in this embodiment, the transparent substrates 210 are rectangular plates, and each one of the transparent substrates 210 includes two lateral sides 211 and a bottom 212 connected between the two lateral sides 211; a bottom edge of the bottom 212 includes an insertion piece 213 extended therefrom and corresponding to one of the pair of locking slots 110 disposed in a radial direction. Each one of the transparent substrates 210 is arranged perpendicular to the control circuit board 100, and the plurality of transparent substrates 210 are arranged on the same side of one side of control circuit board 100; each one of the transparent substrates 210 is perpendicularly attached to the control circuit board with the insertion piece 213 thereof being inserted into the locking slot 110 formed on the control circuit board 100 correspondingly. However, it can be understood that the attachment method between the control circuit board 100 and the transparent substrates 210 of the present invention is not limited to such insertion only but can also be achieved by soldering, adhesion and fastening. In addition, each one of the transparent substrates 210 is electrically connected to the control circuit board 100; preferably, it can be achieved by allowing the insertion pieces 213 to be electrically connected to the locking slots 110 such that the transparent substrates 210 are electrically connected to the control circuit board 100). Each one of the transparent substrates 210 is disposed of a plurality of LED chips 220; for example, the LED chips 220 can be disposed on the same side of one side of the transparent substrate 210 or they can be disposed on two opposite sides of the transparent substrate 210; alternatively, they can also be embedded and disposed at the inner of the transparent substrate 210, and the present invention is not limited to any of the above. The plurality of LED chips 220 are electrically connected to the control circuit board 100 via the transparent substrate 210. One lateral side 211 of each one of the transparent substrates 210 is arranged adjacent to each other; and preferably, the angle between any two of the adjacent transparent substrates 210 is the same throughout such that the plurality of transparent substrates 210 are arranged in a radial pattern at an equal angle among each other.

The power circuit board 300 is provided to be electrically connected to a power source, such as the on-grid power. The power circuit board 300 and the transparent substrates 210 are arranged on two opposite sides of the control circuit board 100 and are electrically connected to the control circuit board 100. A top edge of the power circuit board 300 includes a pair of insertion pieces 310 and the insertion pieces 310 are inserted into the locking slots 120 correspondingly such that the power circuit board 300 is attached to the control circuit board 100. Preferably, the insertion pieces 310 of the power circuit board 300 are electrically connected to the locking slots 120 of the control circuit board 100 correspondingly such that the power circuit board 300 is electrically connected to the control circuit board 100 and is further electrically connected to the LED chips 220 in order to provide power for driving the LED chips 220 to emit light.

The light reflective shield 400 is generally of a cup shape having a tapered profile from the top end 410 toward the bottom end 420 while the top end 410 is an opening. The control circuit board 100 is preferably fastened to the inner side of the bottom end 420 of the light reflective shield 400 to allow the light reflective shield 400 to surround the plurality of lighting modules 200. The insertion pieces 310 of the power circuit board 300 are preferably penetrating through the bottom end 420 of the light reflective shield 400 to be further inserted into the control circuit board 100. The light reflective shield 400 can be used for protecting the lighting modules 200 and reflecting as well as adjusting the angle of the projection of the light emitted therefrom.

In the LED lighting fixture of the present invention, the number of lighting modules 200 is not limited that mentioned in the embodiment above. The LED lighting fixture can include different number of lighting modules 200 according to the needs and configurations while one side of each one of these lighting modules 200 is arranged adjacent to each other and disposed in a radial pattern at an equal angle among each other. With such configuration, the LED lighting fixture of the present invention is able to provide a uniformly distributed illumination to the lateral sides thereof at a 360 degree range. In addition, by arranging the transparent substrates 210 in a radial pattern at equal angle among each other, the LED chips 220 can be disposed on two sides of the transparent substrates 210 such that the light emitted by the LED chips 220 is able to cover a wide degree of angles for illumination. Therefore, the LED lighting fixture of the present invention is able to reduce the working power required by the LED chips 220 and to further decrease the heat generated by the LED chips 220. Consequently, the LED lighting fixture of the present invention is able to only use the light reflective shield 400 for dissipating the heat generated by the lighting modules 200 to the surrounding air sufficiently, and the LED lighting fixture requires no use of extra heat dissipating mechanisms at all.

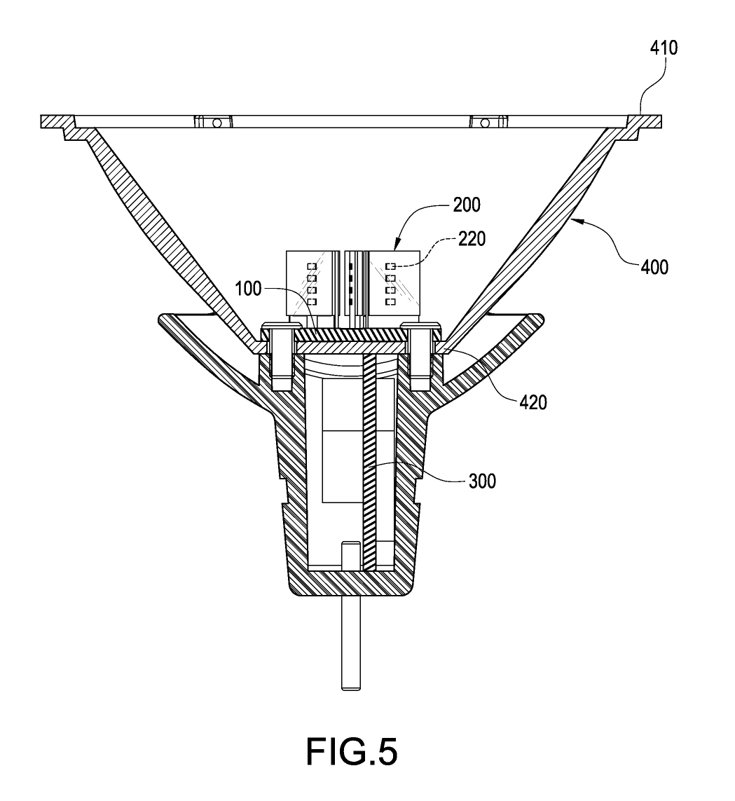

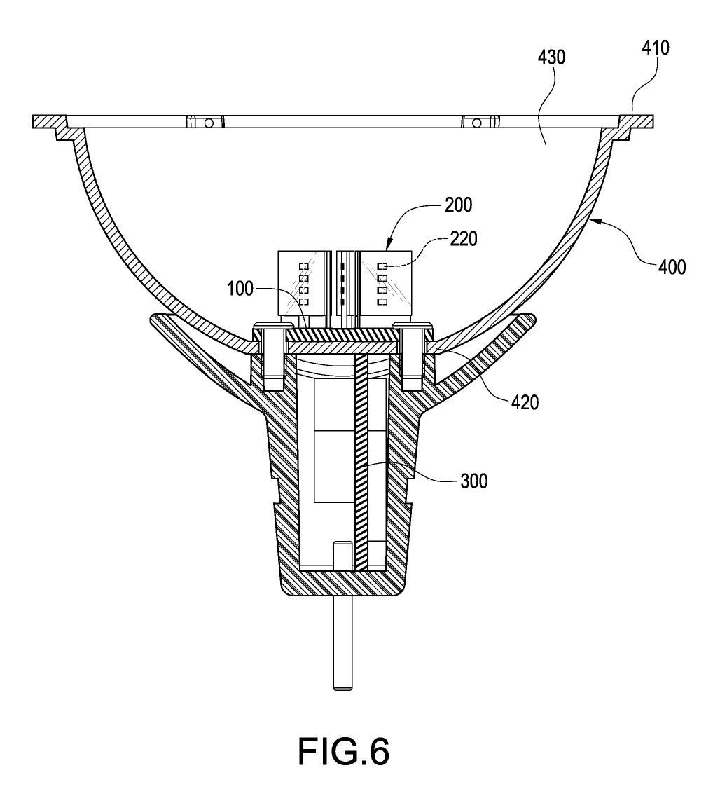

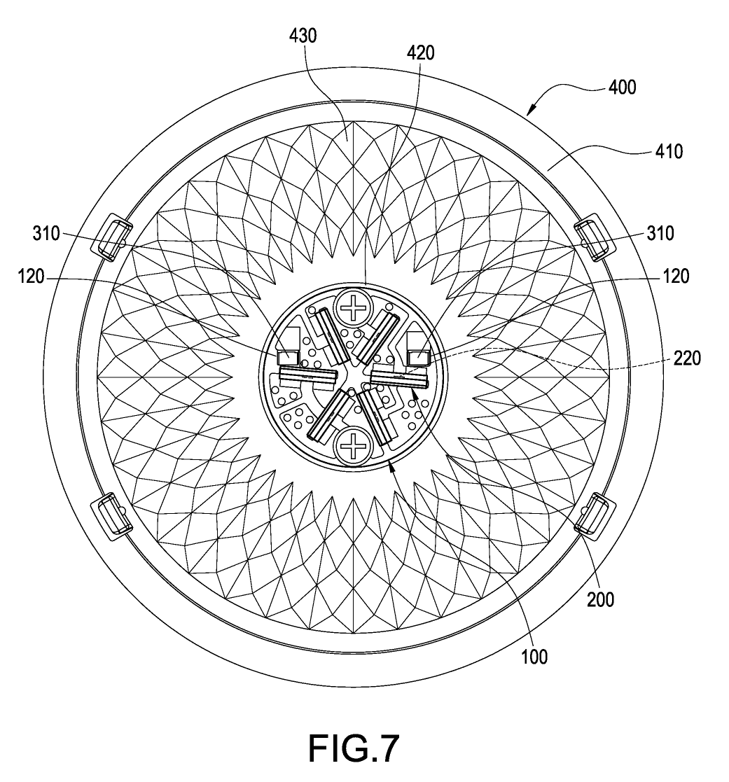

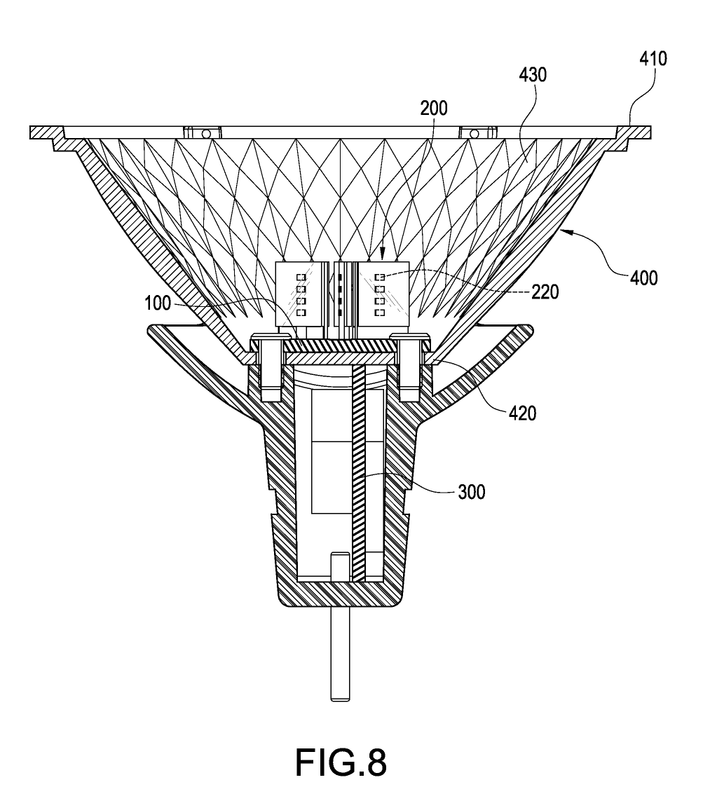

Furthermore, the LED lighting fixture of the present invention uses the light reflective shield 400 for reflecting and adjusting the angle of the light projection of the lighting modules 200, in which it can be of a smoothly curved surface or it can be of cone surface, as shown in FIG. 5. However, the present invention is not limited to such shapes only; for example, the inner wall of the light reflective shield 400 may include a light reflective surface 430 of a smoothly curved surface, as shown in FIG. 6. In addition, as shown in FIG. 7 and FIG. 8, the inner wall of the light reflective shield 400 can also include a plurality of flat light reflective surfaces 430 arranged to face toward different directions such that the light emitted by the lighting modules 200 without specific directions can be re-directed to focus at a certain direction of projection by the plurality of light reflective surfaces 430. Preferably, the plurality of light reflective surfaces 430 are arranged to face toward the lighting modules 200 such that he light emitting by the lighting modules 200 are reflected toward one direction only; however, the light reflective surfaces 430 can also be modified to deviate at an angle from a direction along the alignment with the lighting modules 200 such that the light shape of the projection can be adjusted. Therefore, the LED lighting fixture of the present invention, unlike the know arts, requires no secondary lens at all and such that the manufacturing cost is significantly lowered. The above provides preferred embodiments of the present invention for illustration purposes only, and the present invention shall not be limited to such embodiments only; any other equivalent modification within the spirit of the present invention shall be deemed to be within the scope of the present invention.

What is claimed is:

1. A light emitting diode (LED) lighting fixture, comprising:
a control circuit board;
a plurality of lighting modules, each one of the lighting modules comprising a transparent substrate having a plurality of LED chips disposed thereon, each one of the transparent substrates electrically connected to the control circuit board and the plurality of LED chips electrically connected to the control circuit board via the transparent substrates, one side of each one of the transparent substrates arranged adjacent to each other, and the plurality of transparent substrates arranged in a radial pattern; and
a light reflective shield for accommodating the control circuit board therein, the light reflective shield surrounding the plurality of lighting modules.

2. The LED lighting fixture according to claim 1, wherein a bottom edge of each one of the plurality of transparent substrates is perpendicularly attached to the control circuit board.

3. The LED lighting fixture according to claim 2, wherein a bottom edge of each one of the plurality of transparent substrates includes an insertion piece extended therefrom; the control circuit board includes locking slots corresponding to each one of the insertion pieces; the insertion pieces are inserted into the locking slots.

4. The LED lighting fixture according to claim 3, wherein the insertion pieces are electrically connected to the locking slots.

5. The LED lighting fixture according to claim 1, wherein the plurality of transparent substrates are arranged at an equal angle among each other.

6. The LED lighting fixture according to claim 1, further comprising a power circuit board electrically connected to the control circuit board.

7. The LED lighting fixture according to claim 6, wherein a top edge of the power circuit board is perpendicularly connected to the control circuit board.

8. The LED lighting fixture according to claim 7, wherein the top edge of the power circuit board includes an insertion piece extended therefrom; the control circuit board includes a locking slot corresponding to the insertion piece; the insertion piece is inserted into the locking slot.

9. The LED lighting fixture according to claim 8, wherein the insertion piece is electrically connected to the locking slot.

10. The LED lighting fixture according to claim 6, wherein the power circuit board and the plurality of transparent substrates are arranged at two opposite sides of the control circuit board.

11. The LED lighting fixture according to claim 1, wherein an inner wall of the light reflective shield includes a plurality of flat light reflective surfaces arranged to face toward different directions.

12. The LED lighting fixture according to claim 11, wherein the plurality of light reflective surfaces are arranged to face toward the plurality of lighting modules.

13. The LED lighting fixture according to claim 1, wherein an inner wall of the light reflective shield includes a light reflective surface, and the light reflective surface is a smoothly curved surface.
